(19) United States
(12) Patent Application Publication
(10) Pub. No.: US 2026/0307716 A1
(43) Pub. Date: Oct. 8, 2026

(54) STEERING CONTROL SYSTEM AND METHOD FOR PERFORMING REPROGRAMMING

(71) Applicant: HL MANDO CORPORATION, Gyeonggi-do (KR)

(72) Inventor: Jaeyoung LEE, Gyeonggi-do (KR)

(21) Appl. No.: 19/639,000

(22) Filed: Apr. 3, 2026

(30) Foreign Application Priority Data
Apr. 4, 2025 (KR) 10-2025-0044259

(51) Int. Cl. B62D 6/00; G06F 21/56; G06F 21/57; G06F 21/60

(52) U.S. Cl. CPC B62D 6/008; G06F 21/565; G06F 21/572; G06F 21/602

(57) ABSTRACT

The present disclosure can provide a Steer by Wire (SbW) steering control system performing reprogramming, the steering control system comprising: an input-side steering control device comprising a first input-side control module and a second input-side control module configured to control an input-side steering motor connected to a steering wheel, wherein the first input-side control module is configured to, when a second signed firmware is not received by the second input-side control module from a communication device, receive a third signed firmware, in which a first firmware and the second signed firmware are integrated, from the communication device, perform an integrity verification procedure on the third signed firmware to obtain the second signed firmware, and transmit the second signed firmware to the second input-side control module.

### CROSS-REFERENCE TO RELATED APPLICATION

This application claims priority from Korean Patent Application No. 10-2025-0044259, filed on Apr. 4, 2025, which is hereby incorporated by reference for all purposes as if fully set forth herein.

### BACKGROUND

### Field

The present embodiments relate to a steering control system and method for performing reprogramming.

### Description of Related Art

Recently, a Steer-by-Wire (SbW) steering device has been developed and applied, which allows steering of a vehicle to be performed using an electric motor such as a motor by removing mechanical connection devices such as a steering column, a universal joint, and a pinion shaft between a steering wheel and wheels.

An SbW-type steering control system is a method of controlling steering through electrical signals without mechanical connection elements. Therefore, it is necessary to ensure a higher level of safety for the SbW-type steering control system. For this reason, a method of securing redundancy by duplicating a steering control system of a vehicle is being applied. By operating two redundant control systems, even if one system fails, the other system can operate normally to control steering. Through this, safety can be maintained even when a failure occurs.

Meanwhile, in the case of a steering control system, it is necessary to perform reprogramming when a function is updated or an error is discovered. To this end, a controller in the steering control system is reprogrammed by applying firmware for reprogramming. In this regard, in a case where the steering control system is redundant, a specific design for performing reprogramming using firmware is required.

### SUMMARY

The present embodiments may provide a steering control system and method capable of performing reprogramming even when a failure occurs on one side of a redundant steering control system.

In one aspect, the present embodiments may provide a Steer by Wire (SbW) steering control system performing reprogramming, the steering control system comprising: an input-side steering control device comprising a first input-side control module and a second input-side control module configured to control an input-side steering motor connected to a steering wheel, wherein the first input-side control module and the second input-side control module are configured to receive a first signed firmware and a second signed firmware from a communication device, respectively, in a normal state, and perform the reprogramming by applying a first valid firmware and a second valid firmware obtained through an integrity verification procedure, respectively, and wherein the first input-side control module is configured to, when the second signed firmware is not received by the second input-side control module from the communication device, receive a third signed firmware, in which a first firmware and the second signed firmware are integrated, from the communication device, perform the integrity verification procedure on the third signed firmware to obtain the second signed firmware, and transmit the second signed firmware to the second input-side control module.

In another aspect, the present embodiments may provide a reprogramming method performed in a Steer by Wire (SbW) steering control system comprising an input-side steering control device comprising a first input-side control module and a second input-side control module configured to control an input-side steering motor connected to a steering wheel, the method comprising: receiving, by the first input-side control module, a first signed firmware from a communication device in a normal state, and performing reprogramming by applying a first valid firmware obtained through an integrity verification procedure; and receiving, by the second input-side control module, a second signed firmware from the communication device in a normal state, and performing reprogramming by applying a second valid firmware obtained through the integrity verification procedure, wherein the method further comprises, when the second signed firmware is not received by the second input-side control module from the communication device, receiving, by the first input-side control module, a third signed firmware, in which a first firmware and the second signed firmware are integrated, from the communication device, performing the integrity verification procedure on the third signed firmware to obtain the second signed firmware, and transmitting the second signed firmware to the second input-side control module.

In still another aspect, the present embodiments may provide a control system performing reprogramming, the control system comprising: a control device comprising a first control module and a second control module configured to be mutually redundant to control a first control target, wherein the first control module and the second control module are configured to receive a first signed firmware and a second signed firmware from a communication device, respectively, in a normal state, and perform the reprogramming by applying a first valid firmware and a second valid firmware obtained through an integrity verification procedure, respectively, and wherein the first control module is configured to, when the second signed firmware is not received by the second control module from the communication device, receive a third signed firmware, in which a first firmware and the second signed firmware are integrated, from the communication device, perform the integrity verification procedure on the third signed firmware to obtain the second signed firmware, and transmit the second signed firmware to the second control module.

According to the present embodiments, it is possible to provide a steering control system and method capable of performing reprogramming even when a failure occurs on one side of a redundant steering control system.

Furthermore, according to the present embodiments, when a failure occurs in a communication interface on one side of a redundant steering control system, a steering control device in the steering control system can be reprogrammed while avoiding cyber security threats.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic configuration diagram for explaining a steering system according to the present embodiments;

FIG. 2 is a diagram for explaining an overall system for executing reprogramming in a steering control system according to the present embodiments;

FIG. 3 is a configuration diagram for explaining a steering control system according to the present embodiments;

FIG. 4 is a diagram for explaining an operation of generating signed firmware according to the present embodiments;

FIG. 5 is a diagram for explaining an operation of authenticating signed firmware according to the present embodiments;

FIG. 6 is a diagram for explaining an operation of generating integrated signed firmware according to the present embodiments;

FIGS. 7 and 8 are diagrams for explaining an operation of authenticating integrated signed firmware according to the present embodiments;

FIG. 9 is a flowchart of a reprogramming method performed in a steering control system according to the present embodiments;

FIG. 10 is a diagram for explaining a method of performing reprogramming using first and second signed firmwares according to the present embodiments;

FIG. 11 is a diagram for explaining a method of performing reprogramming using integrated signed firmware according to the present embodiments;

FIG. 12 is a configuration diagram of an exemplary computing system according to the present embodiments.

### DETAILED DESCRIPTION

Hereinafter, some embodiments of the present disclosure will be described in detail with reference to exemplary drawings. In adding reference numerals to components of each drawing, the same components may have the same numerals as much as possible even if they are displayed on different drawings. In addition, in describing the present embodiments, if it is determined that a detailed description of a related known configuration or function may obscure the gist of the present technical idea, the detailed description may be omitted. When “includes,” “has,” “consists of,” etc., mentioned in the present specification are used, other parts may be added unless “only” is used. In a case where a component is expressed in the singular, a case including the plural may be included unless otherwise explicitly stated.

In addition, in describing the components of the present disclosure, terms such as first, second, A, B, (a), and (b) may be used. These terms are only for distinguishing the component from other components, and the essence, order, sequence, or number of the component is not limited by the term.

In the description of the positional relationship of components, when it is described that two or more components are “connected,” “coupled,” or “joined,” etc., the two or more components may be directly “connected,” “coupled,” or “joined,” but it should be understood that other components may be further “interposed” between the two or more components and the components may be “connected,” “coupled,” or “joined.” Here, the other components may be included in one or more of the two or more components that are “connected,” “coupled,” or “joined” to each other.

In the description of temporal sequence relationships related to components, operation methods, manufacturing methods, etc., for example, when temporal sequence relationships or flow sequence relationships are described as “after,” “subsequent to,” “next to,” “before,” etc., non-continuous cases may also be included unless “immediately” or “directly” is used.

Meanwhile, when numerical values or corresponding information (e.g., level, etc.) for components are mentioned, even if there is no separate explicit description, the numerical values or corresponding information may be interpreted as including an error range that may occur due to various factors (e.g., process factors, internal or external impact, noise, etc.).

In the present disclosure, firmware refers to data used for reprogramming in a steering control system, and may also be referred to as plaintext firmware. In addition, signed firmware refers to firmware that has undergone a digital signature procedure using a private key. In addition, valid firmware refers to firmware whose integrity has been verified by applying an integrity verification procedure using a public key to the signed firmware.

Hereinafter, a steering control system and method for performing reprogramming according to embodiments of the present disclosure will be described with reference to the related drawings.

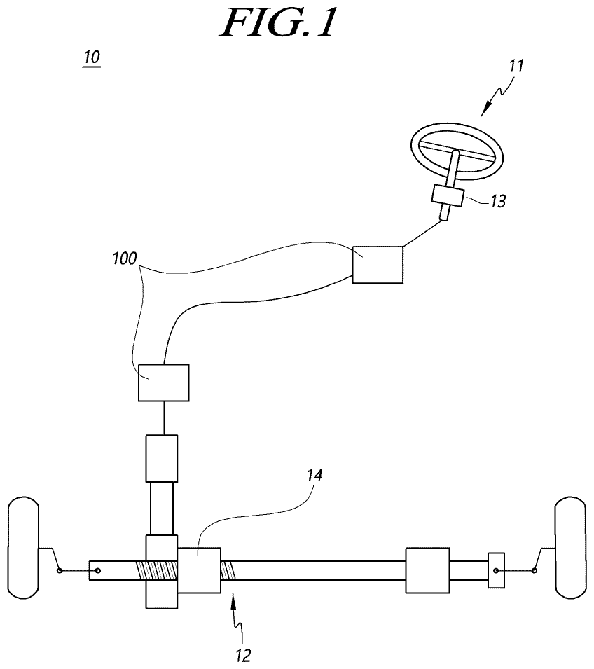

FIG. 1 is a schematic configuration diagram for explaining a steering system according to the present embodiments.

Referring to FIG. 1, a steering system 10 according to the present disclosure is implemented in a Steer by Wire (SbW) manner and may comprise a Steering Feedback Actuator (SFA) 11, a steering control system 100, a Road Wheel Actuator (RWA) 12, and the like. When the steering system 10 is an SbW system, the SFA 11 and the RWA 12 may be mechanically separated.

According to an example, as shown in FIG. 1, the steering control system 100 may be implemented by being divided into an input-side steering control device that controls an operation of the SFA 11 and an output-side steering control device that controls an operation of the RWA 12. However, this is an example, and the steering control system 100 may be implemented as one device. In addition, according to an example, the input-side steering control device may be implemented to be included in the SFA 11, and the output-side steering control device may be implemented to be included in the RWA 12.

The SFA 11 may comprise a steering wheel, a steering shaft, and a reaction force motor 13. In addition, although not shown, it may further comprise a steering gear that transmits rotational force of the reaction force motor 13 to the steering shaft.

The steering wheel may rotate between a left steering lock end and a right steering lock end with the steering shaft as a rotation axis. Here, the lock end may refer to a limit point to which the steering wheel can move. The lock end may be configured with a steering damper or the like.

The reaction force motor 13 may receive a command current from the steering control system 100 and provide reaction torque (feedback torque) to the steering wheel. In one embodiment, the reaction force motor 13 may receive the command current from the steering control system 100, generate the reaction torque by being driven at a rotational speed indicated by the command current, and transmit the reaction torque to the steering wheel through a worm and a wormwheel.

The SFA 11 may comprise a steering angle sensor that detects a steering angle of the steering wheel, a torque sensor that detects driver torque, a steering angular velocity sensor that detects a steering angular velocity of the steering wheel, and the like.

The steering control system 100 may receive steering control information from each of the sensors included in the SFA 11, calculate a control value, and output an electrical signal indicating the control value to the RWA 12. Here, the steering control information may refer to information comprising at least one of the steering angle, the steering angular velocity, and the driver torque.

Meanwhile, the steering control system 100 may receive feedback of power information (e.g., rack position information) actually output from the RWA 12, calculate a control value, and output an electrical signal indicating the control value to the SFA 11 to provide a steering feel (steering sensation) to a driver. The RWA 12 may refer to a device that drives an actual vehicle to steer. Such an RWA 12 may comprise a steering motor 14, a rack, a front wheel, a vehicle speed sensor, a rack position sensor, and the like.

In addition, the SFA 11 and the RWA 12 may further comprise a motor torque sensor capable of sensing motor torque of a reaction force motor and the steering motor 14.

The steering motor 14 may move the rack in an axial direction. Specifically, the steering motor 14 may be driven by receiving a command current from the steering control system 100 and cause the rack to linearly move in the axial direction. That is, the rack may linearly move between a left lock end, which is a left movement limit point, and a right lock end, which is a right movement limit point.

The rack may perform linear movement by driving of the steering motor 14, and the front wheel may be steered to the left or right through the linear movement of the rack.

Although not shown, the steering system 10 may further comprise a clutch or the like capable of separating or coupling the SFA 11 and the RWA 12. Here, the clutch may operate under control of the steering control system 100.

Meanwhile, when the steering system 10 is an SbW system and the vehicle travels in an autonomous driving mode, the steering system 10 may perform steering control of the vehicle by controlling only the RWA 12 or perform steering control of the vehicle by controlling both the SFA 11 and the RWA 12.

The configuration of the steering system 10 shown in FIG. 1 is an example and is not limited thereto. The steering system 10 may further comprise other components as necessary, or some components may be omitted. In this case, according to an example, each component of the steering system may be combined with each other to be implemented as one according to a vehicle control method, and some components may be omitted.

The steering control system 100 may be implemented as at least one of hardware such as an Electronic Control Unit (ECU) comprising a Micro Controller Unit (MCU), an inverter, a Printed Circuit Board (PCB), and the like, software, and a combination thereof.

The steering control system 100 is a device for controlling steering and may generate steering control information based on signals obtained from inside and outside the vehicle. The information may comprise internal information such as a reaction force motor angle signal, a rack stroke signal, a driving motor angle signal, a torque signal, a steering angle signal, and a yaw rate signal used to control steering of the vehicle, and sensing information about the outside of the vehicle. Accordingly, the steering control system 100 may control a steering device, a braking device, and the like of the vehicle based on the steering control information.

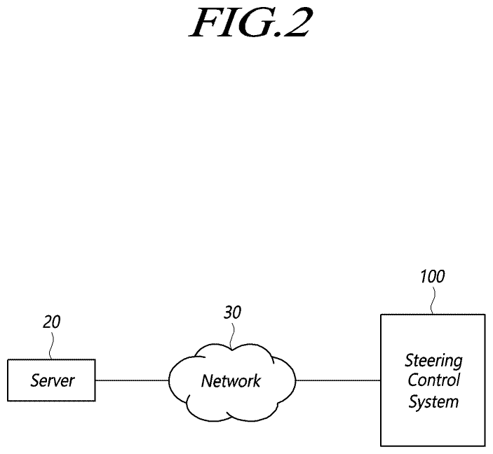

FIG. 2 is a view for explaining an overall system 1 for executing reprogramming in a steering control system according to the present embodiments.

Referring to FIG. 2, the overall system 1 for executing reprogramming in the steering control system may comprise the steering control system 100, a server 20, and a wireless network 30.

According to an example, when reprogramming such as an update of software used for operation of a steering control device in the system is required, the steering control system 100 may update the software through a wireless network according to an Over-The-Air (OTA) method. That is, the steering control system 100 may remotely update the software of the vehicle without a physical connection according to the OTA method.

To this end, the steering control system 100 may receive firmware for software update from the server 20 through the network 30 and update the software using the received firmware. In this case, for security, the firmware may be transmitted in the form of signed firmware, that is, together with a hash value of the firmware encrypted with a private key. According to an example, the signed firmware may be generated in the server 20 or may be generated in a predetermined development device and uploaded to the server 20.

When receiving the signed firmware, the steering control system 100 may perform an integrity verification procedure on the signed firmware using a public key. That is, the hash value of the firmware may be decrypted using the public key, and whether it matches a hash value calculated from the received firmware may be compared. The steering control system 100 may reprogram the software using valid firmware whose integrity has been verified, that is, which has been verified as valid. If the hash values do not match each other, the steering control system 100 may perform a subsequent procedure according to an error without performing an update using the received firmware.

Hereinafter, specific embodiments of reprogramming will be described with reference to the related drawings on the premise that a steering control system of a vehicle is implemented as a redundant system of a Steer by Wire (SbW) type. However, the embodiments described below are not limited to the SbW steering control system, and may be applied substantially identically to other control devices implemented using a redundancy concept as long as they do not contradict the technical spirit of the present disclosure. That is, according to an example, a control system performing reprogramming may comprise a control device comprising a first control module and a second control module configured to be mutually redundant to control a first control target. The first control module and the second control module may receive a first signed firmware and a second signed firmware from a communication device, respectively, in a normal state, and perform reprogramming by applying a first valid firmware and a second valid firmware obtained through an integrity verification procedure, respectively. When the second signed firmware is not received by the second control module from the communication device, the first control module may receive a third signed firmware, in which a first firmware and the second signed firmware are integrated, from the communication device, perform the integrity verification procedure on the third signed firmware to obtain the second signed firmware, and transmit the second signed firmware to the second control module.

Hereinafter, a reprogramming method in a case where a steering control system is redundant to ensure redundancy will be described with reference to the related drawings.

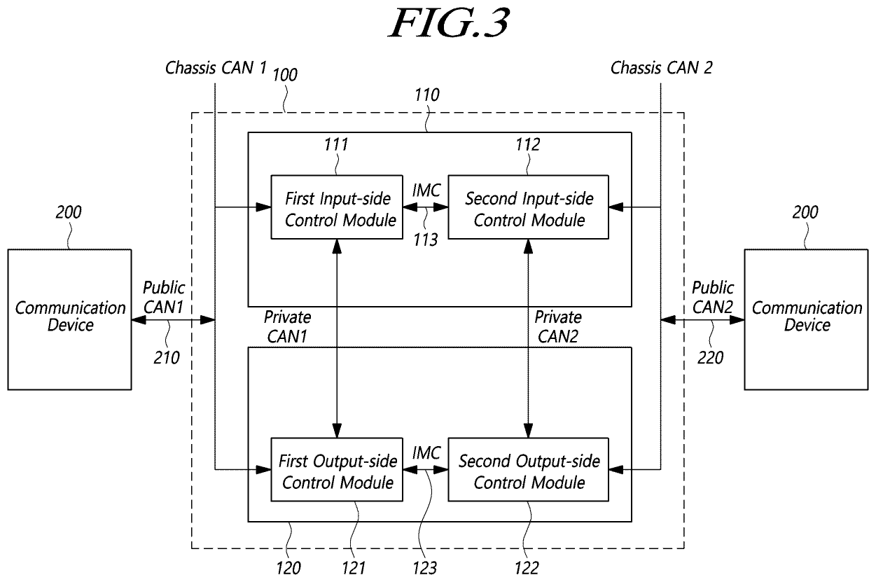

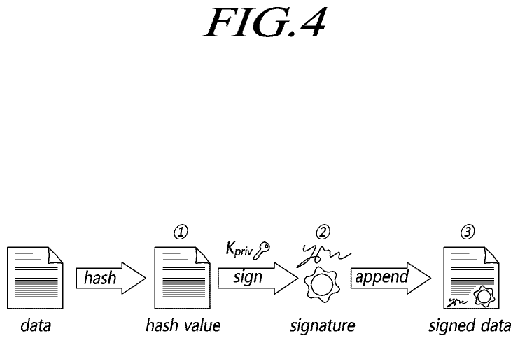

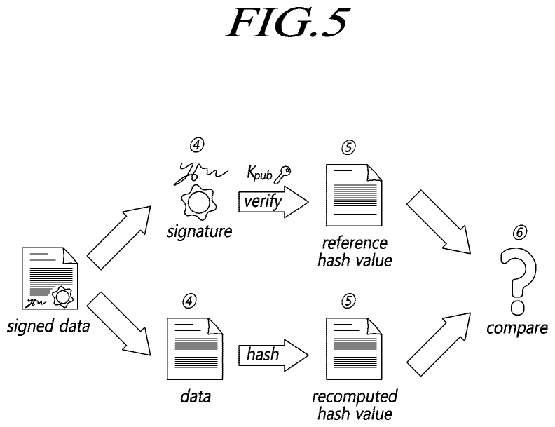

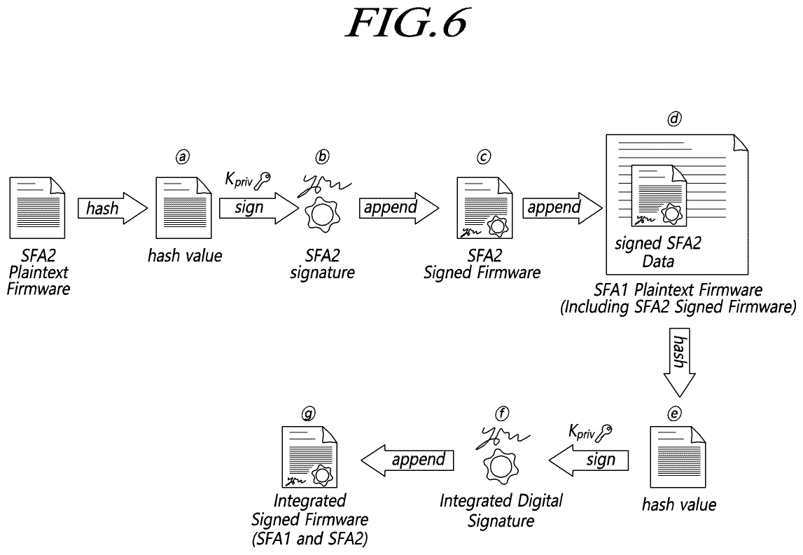

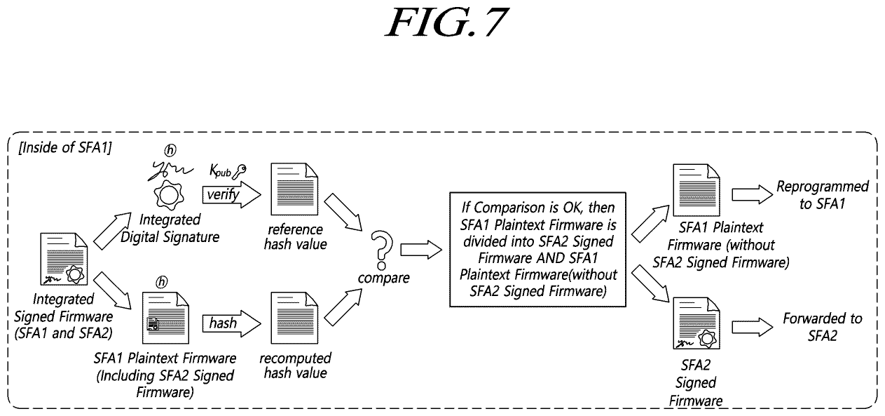

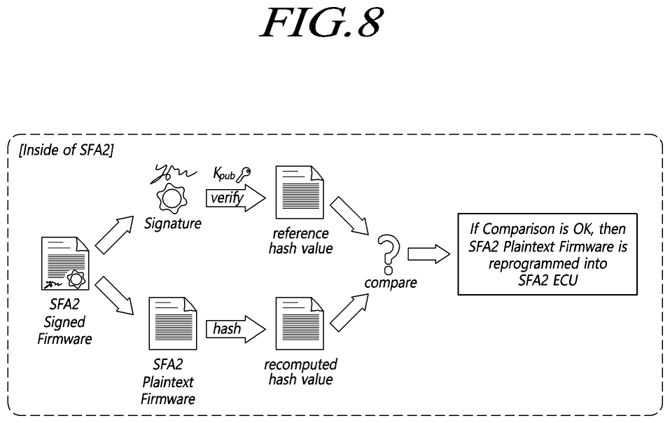

FIG. 3 is a configuration diagram for explaining a steering control system according to the present embodiments. FIG. 4 is a diagram for explaining an operation of generating a signed firmware according to the present embodiments. FIG. 5 is a diagram for explaining an operation of authenticating a signed firmware according to the present embodiments. FIG. 6 is a diagram for explaining an operation of generating an integrated signed firmware according to the present embodiments. FIGS. 7 and 8 are diagrams for explaining an operation of authenticating an integrated signed firmware according to the present embodiments.

Referring to FIG. 3, a Steer by Wire (SbW) steering control system 100 performing reprogramming may comprise an input-side steering control device 110 comprising a first input-side control module 111 and a second input-side control module 112 configured to control an input-side steering motor connected to a steering wheel, and an output-side steering control device 120 comprising a first output-side control module 121 and a second output-side control module 122 configured to control an output-side steering motor connected to a wheel. The first input-side control module 111 may be configured to receive a first signed firmware from a communication device in a normal state, and perform reprogramming by applying a first valid firmware obtained through an integrity verification procedure. The second input-side control module 112 may be configured to receive a second signed firmware from the communication device in a normal state, and perform reprogramming by applying a second valid firmware obtained through the integrity verification procedure. The first input-side control module 111 may be configured to, when the second signed firmware is not received by the second input-side control module from the communication device, receive a third signed firmware, in which a first firmware and the second signed firmware are integrated, from the communication device, perform the integrity verification procedure on the third signed firmware to obtain the second signed firmware, and transmit the second signed firmware to the second input-side control module.

As shown in FIG. 3, the steering control system 100 for steering control of a vehicle may comprise two input-side control modules and two output-side control modules, respectively, to ensure redundancy. However, this is an example, and as long as it does not contradict the technical spirit of the present disclosure, even when the number of input-side control modules and output-side control modules is implemented as three or more, the embodiments of the present disclosure may be applied substantially identically.

According to an example, the first input-side control module 111 and the second input-side control module 112 may be configured in a master-slave relationship. In this case, the first input-side control module 111 and the second input-side control module 112 are for convenience of distinction, and when any one of the two control modules operates as a master, the other may be configured to operate as a slave. Alternatively, according to another example, the first input-side control module 111 and the second input-side control module 112 may be configured to operate in an equal relationship with each other.

Hereinafter, an operation of the first input-side control module 111 will be described on the assumption that a failure occurs on the second input-side control module 112 side, but this is for convenience of description and may be applied substantially identically to the opposite case. That is, the following description of the operation of the first input-side control module 111 may be applied substantially identically to an operation of the second input-side control module 112 when a failure occurs on the first input-side control module 111 side.

Similarly, according to an example, the first output-side control module 121 and the second output-side control module 122 may be configured in a master-slave relationship. In this case, the first output-side control module 121 and the second output-side control module 122 are for convenience of distinction, and when any one of the two control modules operates as a master, the other may be configured to operate as a slave. Alternatively, according to another example, the first output-side control module 121 and the second output-side control module 122 may be configured to operate in an equal relationship with each other.

Hereinafter, an operation of the first output-side control module 121 will be described on the assumption that a failure occurs on the second output-side control module 122 side, but this is for convenience of description and may be applied substantially identically to the opposite case. That is, the following description of the operation of the first output-side control module 121 may be applied substantially identically to an operation of the second output-side control module 122 when a failure occurs on the first output-side control module 121 side.

The first input-side control module 111 may receive the first signed firmware from the communication device 200 through a public CAN, which is a first communication channel 210. The first signed firmware may be received from a server, as described above.

Referring to FIG. 4, a hash value of a first firmware (data) to be used for reprogramming of the first input-side control module 111 may be obtained (\textcircled{1}). According to an example, an algorithm such as SHA-256 (Secure Hash Algorithm 256-bit) may be applied to calculate the hash value. However, this is an example, and as long as the hash value can be calculated, it is not limited to a specific algorithm. A digital signature may be generated for the obtained hash value of the first firmware using a private key (\textcircled{2}). According to an example, an algorithm such as RSA 2048 (Rivest-Shamir-Adleman 2048-bit) may be applied to generate the digital signature. However, this is an example, and as long as the digital signature can be generated, it is not limited to a specific algorithm. Thereafter, the first signed firmware may be generated by attaching the generated digital signature to the first firmware (\textcircled{3}).

Such a first signed firmware may be generated in the server 20 or generated in a predetermined development device and uploaded to the server 20. The external server 20 may transmit the first signed firmware to the communication device 200 of the vehicle. Transmission of the first signed firmware may be performed according to a predetermined period, a transmission input from the development device, a request from an in-vehicle device such as the first input-side control module 111, or the like.

The description of the first signed firmware described above may be applied identically to the generation of the second signed firmware. That is, the second signed firmware may be generated by performing the same procedure on a second firmware to be used for reprogramming of the second input-side control module 112.

The first input-side control module 111 may receive the first signed firmware from the communication device 200 through the public CAN, which is the first communication channel 210. The first input-side control module 111 may obtain the first valid firmware through an integrity verification procedure for the first signed firmware. Thereafter, the first input-side control module 111 may perform reprogramming by applying the first valid firmware.

Referring to FIG. 5, the first input-side control module 111 may separate and divide a digital signature and a firmware area from the first signed firmware (\textcircled{4}). The first input-side control module 111 may obtain a hash value whose validity is verified using a public key for the separated digital signature, and calculate a hash value by applying a hash algorithm to the separated firmware (\textcircled{5}). The first input-side control module 111 may compare the verified hash value with the calculated hash value (\textcircled{6}). When the two hash values are identical, the first input-side control module 111 may perform reprogramming by applying the first valid firmware, which is the separated firmware. When the two hash values are not identical, the first input-side control module 111 may delete the invalid separated firmware and determine that the reprogramming has failed. Thereafter, the first input-side control module 111 may perform a subsequent procedure such as outputting a warning that the firmware is invalid or transmitting a request for a new firmware.

Similarly, the second input-side control module 112 may receive the second signed firmware from the communication device 200 and perform reprogramming by applying a second valid firmware obtained through the integrity verification procedure. In FIG. 3, two communication devices 200 are shown on the left and right of the steering control system 100, but this is for convenience of drawing and may mean the same device.

The second input-side control module 112 may receive the second signed firmware from the communication device 200 through the public CAN, which is a second communication channel 220. Thereafter, since an operation in which the second input-side control module 112 verifies the received second signed firmware, obtains the second valid firmware, and performs reprogramming is substantially the same as the operation in which the first input-side control module 111 obtains the first valid firmware and performs reprogramming described above, a detailed description thereof will be omitted to avoid redundant description.

According to an example, it is assumed that the second signed firmware is not received by the second input-side control module 112 from the communication device 200. For example, such a case may include a case where a failure occurs in the second communication channel 220 between the communication device 200 and the second input-side control module 112.

As such, when the second input-side control module 112 fails to receive the second signed firmware, the second input-side control module 112 cannot perform the aforementioned reprogramming procedure. Accordingly, the first input-side control module 111 may obtain the second signed firmware from the third signed firmware received from the communication device 200 and transmit the second signed firmware to the second input-side control module. The second input-side control module 112 may perform reprogramming using the second signed firmware received from the first input-side control module 111.

According to an example, when the second signed firmware is not received by the second input-side control module 112 from the communication device 200, the first input-side control module 111 may transmit a request signal for the third signed firmware to the external server 20. In this case, the second input-side control module 112 may report non-reception to the first input-side control module 111 through a first Inter Micro Communication (IMC) path 113. In this case, the first input-side control module 111 may request transmission of the third signed firmware to the external server 20 through the communication device 200.

Alternatively, according to another example, when the second signed firmware is not received at a time when it should be received, the second input-side control module 112 may report non-reception to a central control device of the vehicle through Chassis CAN2 communication. In this case, the central control device may request transmission of the third signed firmware to the external server 20 through the communication device 200.

Alternatively, according to another example, when a failure of the second communication channel 220 is confirmed, the central control device may request transmission of the third signed firmware to the external server 20.

The third signed firmware may be generated through a digital signature procedure on data in which a first firmware and the second signed firmware are integrated. That is, the aforementioned first signed firmware, second signed firmware, and third signed firmware may be generated in the external server 20 through a digital signature procedure and transmitted to the communication device 200.

Referring to FIG. 6, the second signed firmware may be obtained for a second firmware to be used for reprogramming of the second input-side control module 112 (\textcircled{a}, \textcircled{b}, \textcircled{c}). Since the corresponding process is substantially the same as that described in FIG. 4, a detailed description thereof will be omitted. The second signed firmware is integrated into the first firmware (\textcircled{d}), and a hash value for a third firmware, which is an integrated firmware, may be calculated (\textcircled{e}). A digital signature may be generated for the hash value of the third firmware using a private key (\textcircled{f}). Thereafter, the third signed firmware, which is an integrated signed firmware, may be generated by attaching the generated digital signature to the third firmware (\textcircled{g}).

Such a third signed firmware may be generated in the external server 20 or may be generated in a predetermined development device and uploaded to the external server 20. The external server 20 may transmit the third signed firmware to the communication device 200 of the vehicle.

The first input-side control module 111 may receive the third signed firmware from the communication device 200 through a public CAN, which is the first communication channel 210. When the second signed firmware is not received by the second control module from the communication device, the first input-side control module 111 may perform an integrity verification procedure on the third signed firmware to obtain a first valid firmware and the second signed firmware. The integrity verification procedure performed on the third signed firmware may comprise verifying validity of a signed hash value of the third signed firmware using a public key, and comparing the verified hash value with a hash value generated from the third signed firmware. Thereafter, the first input-side control module 111 may perform reprogramming by applying the first valid firmware.

Referring to FIG. 7, the first input-side control module 111 may distinguish and separate a digital signature and a third firmware region from the third signed firmware (\textcircled{h}). The first input-side control module 111 may obtain a verified hash value for the separated digital signature using a public key, and calculate a hash value by applying a hash algorithm to the separated third firmware.

The first input-side control module 111 may compare the verified hash value with the calculated hash value. When the two hash values are identical, the first input-side control module 111 may determine that the separated third firmware is valid, and divide the third valid firmware into the first valid firmware and the second signed firmware. Thereafter, the first input-side control module 111 may perform reprogramming by applying the first valid firmware. In addition, the first input-side control module 111 may transmit the second signed firmware to the second input-side control module 112 through the first IMC path 113 between the first input-side control module and the second input-side control module. If the two hash values are not identical, the first input-side control module 111 may delete the invalid third firmware and determine that the reprogramming has failed. Thereafter, the first input-side control module 111 may perform subsequent procedures such as outputting a warning that the third firmware is invalid or transmitting a request for a new third firmware.

Thereafter, the second input-side control module 112 may receive the second signed firmware through the first IMC path 113. The second input-side control module 112 may obtain a second valid firmware through an integrity verification procedure on the second signed firmware. The second input-side control module 112 may perform reprogramming by applying the second valid firmware.

Referring to FIG. 8, the second input-side control module 112 may distinguish and separate a digital signature and a firmware region from the second signed firmware. The second input-side control module 112 may obtain a verified hash value for the separated digital signature using a public key, and calculate a hash value by applying a hash algorithm to the separated firmware. The second input-side control module 112 may compare the verified hash value with the calculated hash value. When the two hash values are identical, the second input-side control module 112 may perform reprogramming by applying the second valid firmware, which is the separated firmware. When the two hash values are not identical, the second input-side control module 112 may delete the invalid separated firmware and determine that the reprogramming has failed. Thereafter, the second input-side control module 112 may perform subsequent procedures such as outputting a warning that the second firmware is invalid or transmitting a request for a new third signed firmware.

Although the above description has been made on the premise that a failure occurs in the input-side steering control device 110 of the steering control system 100, these embodiments of the present disclosure may be applied substantially identically even when a failure occurs in an output-side steering control device 120 comprising a first output-side control module 121 and a second output-side control module 122 configured to control an output-side steering motor connected to a wheel.

That is, the first output-side control module 121 may receive a fourth signed firmware from the communication device 200 and perform reprogramming by applying a fourth valid firmware obtained through an integrity verification procedure. In addition, the second output-side control module 122 may receive a fifth signed firmware from the communication device 200 and perform reprogramming by applying a fifth valid firmware obtained through the integrity verification procedure.

According to an example, when the fifth signed firmware is not received by the second output-side control module 122 from the communication device 200, the first output-side control module 121 may receive a sixth signed firmware, in which a fourth firmware and the fifth signed firmware are integrated, from the communication device 200, and perform the integrity verification procedure on the sixth signed firmware to obtain the fifth signed firmware. In this case, the first output-side control module 121 may transmit the fifth signed firmware to the second output-side control module 122 through a second IMC path 123. Since specific operations related thereto are substantially the same as the operations of the aforementioned input-side steering control device 110, a detailed description thereof will be omitted to prevent redundant description.

In addition, the description of the operation of the first output-side control module 121 described above may be applied substantially identically to the operation of the second output-side control module 122 when the fourth signed firmware is not received by the first output-side control module 121 from the communication device 200.

According to this, it is possible to provide a steering control system capable of performing reprogramming even when a failure occurs on one side of a redundant steering control system. In addition, when a failure occurs in a communication interface on one side of the redundant steering control system, a steering control device in the steering control system can be reprogrammed while avoiding cybersecurity threats.

Hereinafter, a reprogramming method performed in a steering control system capable of performing some or all of the present embodiments described with reference to FIGS. 1 to 8 will be described with reference to the drawings. The above description may be omitted to avoid redundant description, and in this case, the omitted content may be applied substantially identically to the following description as long as it does not contradict the technical spirit of the invention.

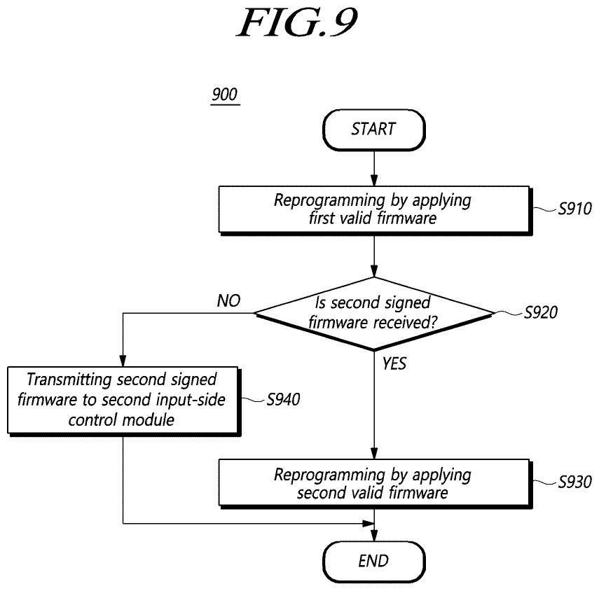

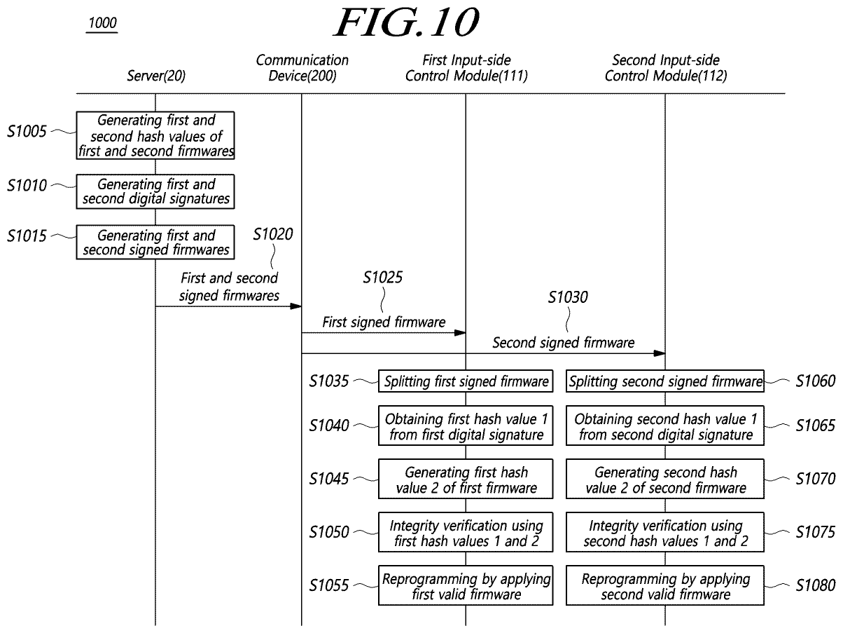

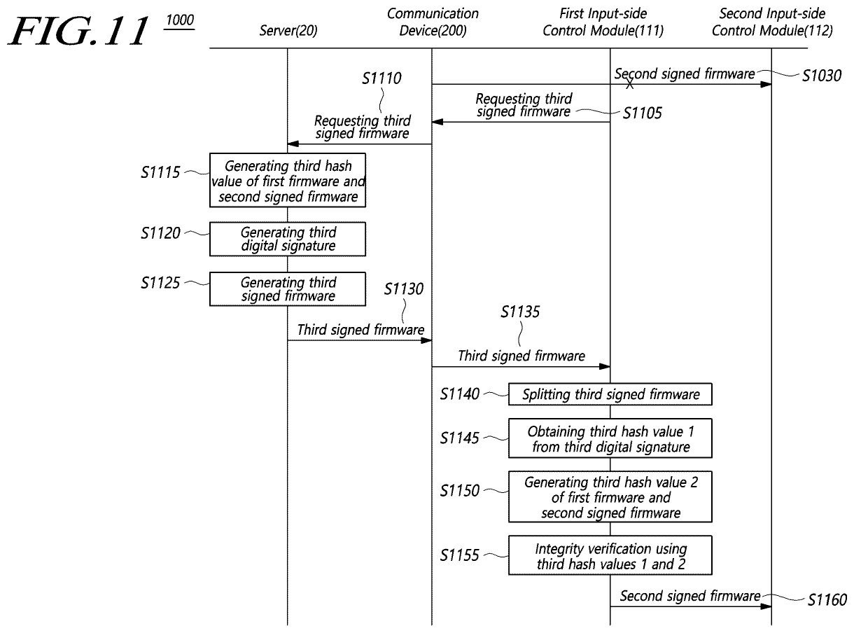

FIG. 9 is a flowchart of a reprogramming method performed in a steering control system according to the present embodiments. FIG. 10 is a view for explaining a method of performing reprogramming using first and second signed firmwares according to the present embodiments. FIG. 11 is a view for explaining a method of performing reprogramming using an integrated signed firmware according to the present embodiments.

Referring to FIG. 9, a first input-side control module may receive a first signed firmware from a communication device in a normal state and perform reprogramming by applying a first valid firmware obtained through an integrity verification procedure (S910).

When the second signed firmware is received by the second input-side control module from the communication device (S920, Yes), that is, in the normal state, the second input-side control module may perform reprogramming by applying a second valid firmware obtained through the integrity verification procedure (S930).

When the second signed firmware is not received by the second input-side control module from the communication device (S920, No), the first input-side control module may receive a third signed firmware in which a first firmware and the second signed firmware are integrated from the communication device. The first input-side control module may obtain the second signed firmware by performing the integrity verification procedure on the third signed firmware and transmit the second signed firmware to the second input-side control module (S940).

Referring to FIG. 10, in a server 20, hash values of a first firmware to be used for reprogramming of the first input-side control module and a second firmware to be used for reprogramming of the second input-side control module may be generated (S1005). A first digital signature and a second digital signature may be generated for each of the obtained hash values of the first firmware and the second firmware using a private key (S1010). Thereafter, the first signed firmware and the second signed firmware may be generated by attaching the generated digital signatures to the first and second firmwares, respectively (S1015).

As such, the first and second signed firmwares may be generated in the server 20 or generated in a predetermined development device and uploaded to the server 20. The server 20 may transmit the first and second signed firmwares to a communication device 200 of a vehicle (S1020). Transmission of the first signed firmware may be performed according to a predetermined cycle, a transmission input from the development device, a request from an in-vehicle device such as the first input-side control module, or the like.

The first input-side control module 111 may receive the first signed firmware from the communication device 200 through a common CAN, which is a first communication channel (S1025). Similarly, the second input-side control module 112 may receive the second signed firmware from the communication device 200 through a common CAN, which is a second communication channel (S1030).

The first input-side control module 111 may obtain the first valid firmware through the integrity verification procedure for the first signed firmware. Thereafter, the first input-side control module 111 may perform reprogramming by applying the first valid firmware. To this end, the first input-side control module 111 may divide the first signed firmware by distinguishing a first digital signature and a first firmware area (S1035). The first input-side control module 111 may obtain a validated first hash value 1 for the separated first digital signature using a public key (S1040). The first input-side control module 111 may generate a first hash value 2 by applying a hash algorithm to the separated first firmware (S1045). The first input-side control module 111 may verify integrity by comparing the validated first hash value 1 with the calculated first hash value 2 (S1050). When the two hash values are identical, the first input-side control module 111 may perform reprogramming by applying the first valid firmware, which is the separated firmware (S1055). When the two hash values are not identical, the first input-side control module 111 may delete the invalid separated firmware and determine that the reprogramming has failed. Thereafter, the first input-side control module 111 may perform subsequent procedures such as outputting a warning that the firmware is invalid or transmitting a request for new firmware.

Similarly, the second input-side control module 112 may receive the second signed firmware from the communication device 200 through the common CAN, which is the second communication channel (S1030). Thereafter, operations (S1060 to S1080) in which the second input-side control module 112 verifies the received second signed firmware, obtains the second valid firmware, and performs reprogramming are substantially identical to the operations in which the first input-side control module 111 obtains the first valid firmware and performs reprogramming, and thus, a detailed description thereof will be omitted to avoid redundant description.

Referring to FIG. 11, the second signed firmware may not be received by the second input-side control module 112 from the communication device 200 (S1030, X). For example, such a case may include a case where a failure occurs in the second communication channel between the communication device 200 and the second input-side control module 112.

As such, when the second input-side control module 112 fails to receive the second signed firmware, the second input-side control module 112 cannot perform the above-described reprogramming procedure. Accordingly, the first input-side control module 111 may obtain the second signed firmware from the third signed firmware received from the communication device 200 and transmit the second signed firmware to the second input-side control module. The second input-side control module 112 may perform reprogramming using the second signed firmware received from the first input-side control module 111.

Referring to FIG. 11, when the second signed firmware is not received by the second input-side control module 112 from the communication device 200, the first input-side control module 111 may transmit a request signal for the third signed firmware to an external server 20 through the communication device (S1105) (S1110). In this case, according to an example, the second input-side control module 112 may first report the non-reception to the first input-side control module 111 through a first IMC path.

The third signed firmware may be generated through a digital signature procedure on data in which the first firmware and the second signed firmware are integrated. That is, the above-described first signed firmware, second signed firmware, and third signed firmware may be generated in the external server 20 through the digital signature procedure and transmitted to the communication device 200.

Referring to FIG. 11, in the server 20, the second signed firmware is integrated into the first firmware, and a third hash value for a third firmware, which is an integrated firmware, may be generated (S1115). A third digital signature may be generated for the third hash value of the third firmware using a private key (S1120). Thereafter, the third signed firmware, which is an integrated signed firmware, may be generated by attaching the generated third digital signature to the third firmware (S1125).

Such a third signed firmware may be generated in the external server 20 or generated in a predetermined development device and uploaded to the external server 20. The external server 20 may transmit the third signed firmware to the communication device 200 of the vehicle (S1130).

The first input-side control module 111 may receive the third signed firmware from the communication device 200 through a public CAN, which is a first communication channel (S1135). The first input-side control module 111 may perform an integrity verification procedure on the third signed firmware to obtain a first valid firmware and the second signed firmware. The integrity verification procedure performed on the third signed firmware may comprise verifying validity of a signed hash value of the third signed firmware using a public key, and comparing the verified hash value with a hash value generated from the third signed firmware. Thereafter, the first input-side control module 111 may perform reprogramming by applying the first valid firmware.

Referring to FIG. 11, the first input-side control module 111 may divide the third signed firmware by distinguishing a digital signature and a third firmware area (S1140). The first input-side control module 111 may obtain a third hash value 1, whose validity is verified, using a public key for the separated third digital signature (S1145), and calculate a third hash value 2 by applying a hash algorithm to the separated third firmware (S1150).

The first input-side control module 111 may perform integrity verification by comparing the verified hash value with the calculated hash value (S1155). When the two hash values are identical, the first input-side control module 111 may determine that the separated third firmware is valid, and divide the third valid firmware into the first valid firmware and the second signed firmware. Thereafter, the first input-side control module 111 may perform reprogramming by applying the first valid firmware. In addition, the first input-side control module 111 may transmit the second signed firmware to the second input-side control module 112 through a first IMC path between the first input-side control module and the second input-side control module (S1160). If the two hash values are not identical, the first input-side control module 111 may delete the invalid third firmware and determine that the reprogramming has failed. Thereafter, the first input-side control module 111 may perform subsequent procedures such as outputting a warning that the third firmware is invalid or transmitting a request for a new third firmware.

Thereafter, the second input-side control module 112 may receive the second signed firmware through the first IMC path. The second input-side control module 112 may obtain a second valid firmware through an integrity verification procedure on the second signed firmware. The second input-side control module 112 may perform reprogramming by applying the second valid firmware.

Although the above description has been made on the premise that a failure occurs in the input-side steering control device 110 of the steering control system 100, these embodiments of the present disclosure may be applied substantially identically even when a failure occurs in an output-side steering control device 120 comprising a first output-side control module 121 and a second output-side control module 122 configured to control an output-side steering motor connected to a wheel.

That is, the first output-side control module 121 may receive a fourth signed firmware from the communication device 200 and perform reprogramming by applying a fourth valid firmware obtained through the integrity verification procedure. In addition, the second output-side control module 122 may receive a fifth signed firmware from the communication device 200 and perform reprogramming by applying a fifth valid firmware obtained through the integrity verification procedure.

According to an example, when the fifth signed firmware is not received by the second output-side control module 122 from the communication device 200, the first output-side control module 121 may receive a sixth signed firmware, in which a fourth firmware and the fifth signed firmware are integrated, from the communication device 200, and perform the integrity verification procedure on the sixth signed firmware to obtain the fifth signed firmware. In this case, the first output-side control module 121 may transmit the fifth signed firmware to the second output-side control module 122 through a second IMC path 123. Since specific operations related thereto are substantially identical to the operations of the input-side steering control device 110 described above, a detailed description thereof will be omitted to avoid redundant description.

In addition, the description of the operation of the first output-side control module 121 described above may be applied substantially identically to the operation of the second output-side control module 122 when the fourth signed firmware is not received by the first output-side control module 121 from the communication device 200.

Accordingly, it is possible to provide a steering control method capable of performing reprogramming even when a failure occurs in one side of a redundant steering control system. In addition, when a failure occurs in a communication interface of one side of the redundant steering control system, a steering control device in the steering control system can be reprogrammed while avoiding cyber security threats.

Meanwhile, the present disclosure may comprise a computing system for performing the embodiments of the steering control system and method for performing the reprogramming described above. That is, the steering control system described above may be implemented as a computing system comprising a plurality of processors and a memory.

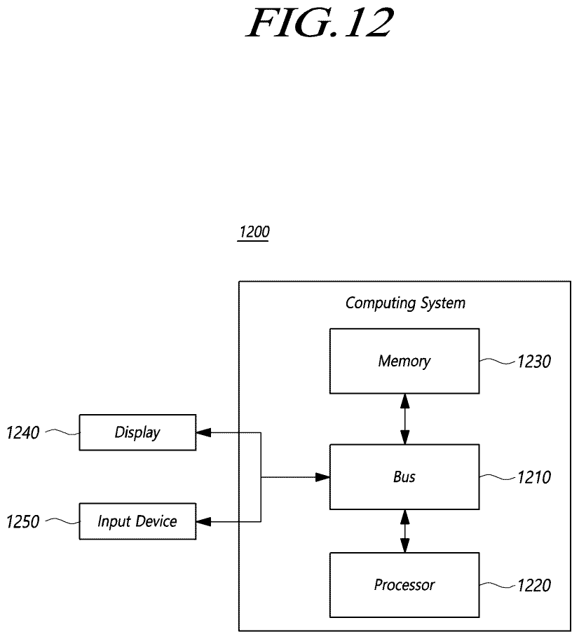

FIG. 12 is a configuration diagram of an exemplary computing system 1200 according to the present embodiments.

A computing system or a computing device may be used to comprise or implement components thereof, such as a system or a data processing system. The computing system comprises a bus 1210 or other communication component for conveying information, and a processor 1220 or processing circuitry coupled to the bus for processing information. The computing system may also comprise one or more processors or processing circuitry coupled to the bus for processing information.

The computing system may also comprise a memory 1230 coupled to the bus for storing information. The memory may comprise instructions to be executed by the processor. According to an example, the memory may comprise at least one of a main memory, a ROM, or a storage device. However, this is only an example and is not limited thereto, and the memory may comprise various known storage devices. The memory may comprise a main memory such as a random access memory (RAM) or other dynamic storage device. The main memory may be or comprise a data store. The main memory may also be used to store location information, temporary variables, or other intermediate information during execution of instructions by the processor. The memory may further comprise a ROM or other static storage device coupled to the bus for storing static information and instructions for the processor. The memory may comprise a storage device such as a solid state device, a magnetic disk, or an optical disk. The storage device may be coupled to the bus for persistently storing information and instructions. The storage device may comprise or be a part of a data store.

The computing system may be coupled via the bus to a display, such as a liquid crystal display 1240 or an active matrix display, for displaying information to a user. An input device 1250, such as a keyboard comprising alphanumeric and other keys, may be coupled to the bus for conveying information and command selections to the processor. The input device may comprise a touch screen display. The input device may also comprise a cursor control, such as a mouse, a trackball, or cursor direction keys, for conveying direction information and command selections to the processor and for controlling cursor movement on the display. The display may be part of a data processing system, a client computing device, or other components.

The processes, systems, and methods described herein may be implemented by a computing system in response to a processor executing an arrangement of instructions contained in a main memory. Such instructions may be read into the main memory from another computer-readable medium, such as a storage device. Execution of the arrangement of instructions contained in the main memory causes the computing system to perform the exemplary processes described herein. In a multi-processing arrangement, one or more processors may also be used to execute the instructions contained in the main memory. Hard-wired circuitry may be used instead of or in combination with software instructions with the systems and methods described herein. The systems and methods described herein are not limited to any specific combination of hardware circuitry and software.

Although an exemplary computing system has been described above, the subject matter comprising the operations described herein may be implemented in other types of digital electronic circuitry, or in computer software, firmware, or hardware comprising the structures disclosed herein and their structural equivalents or combinations of one or more thereof.

A “data processing system”, “computing device”, “module”, “engine”, “component”, or “computing device” comprises various apparatuses, devices, and machines for processing data, comprising, for example, a programmable processor, a computer, a system on a chip, or multiple ones, or combinations thereof. The apparatus may comprise special purpose logic circuitry, for example, a field programmable gate array (FPGA) or an application specific integrated circuit (ASIC). The apparatus may also comprise, in addition to hardware, code that creates an execution environment for the corresponding computer program, for example, code that constitutes processor firmware, a protocol stack, a database management system, an operating system, a cross-platform runtime environment, a virtual machine, or a combination of one or more thereof. The apparatus and execution environment may realize various different computing model infrastructures, such as web services, distributed computing, and grid computing infrastructures. A content request module, a content rendering module, or a rendered content delivery module may comprise or share one or more data processing apparatuses, systems, computing devices, or processors. Components of the system may comprise or share one or more data processing apparatuses, systems, computing devices, or processors.

A computer program (also known as a program, software, software application, app, script, or code) may be written in any form of programming language, comprising compiled or interpreted languages, or declarative or procedural languages, and may be deployed in any form, comprising as a stand-alone program or as a module, component, subroutine, object, or other unit suitable for use in a computing environment. A computer program may or may not correspond to a file in a file system. A computer program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers located at one site or distributed across multiple sites and interconnected by a communication network.

The processes and logic flows described herein may be performed by one or more programmable processors executing one or more computer programs (e.g., components of a data processing system) to perform actions by operating on input data and generating output. The processes and logic flows may also be performed by, and apparatuses may also be implemented by, special purpose logic circuitry, for example, a field programmable gate array (FPGA) or an application specific integrated circuit (ASIC). Apparatuses suitable for storing computer program instructions and data comprise all forms of non-volatile memory, media, and memory devices, comprising, for example, semiconductor memory devices such as EPROM, EEPROM, and flash memory devices; magnetic disks, for example, internal hard disks or removable disks; magneto-optical disks; and CD-ROM and DVD-ROM disks. The processor and the memory may be supplemented by or integrated with special purpose logic circuitry.

The apparatuses, methods, configurations, subject matter, and operations described herein may be implemented in digital electronic circuitry, or in computer software, firmware, or hardware comprising the structures disclosed in this specification and their structural equivalents or combinations of one or more thereof. The subject matter described herein may be implemented as one or more modules of computer program instructions encoded on a computer storage medium for execution by a data processing apparatus or to control the operation of a data processing apparatus. The program instructions may be encoded in an artificially generated propagated signal, for example, a machine-generated electrical, optical, or electromagnetic signal generated to encode information for transmission to a suitable receiver apparatus for execution by a data processing apparatus. The computer storage medium may be or be included in a computer-readable storage device, a computer-readable storage substrate, a random or serial access memory array or device, or a combination of one or more thereof. Although the computer storage medium is not a propagated signal, the computer storage medium may be a source or destination of computer program instructions encoded in an artificially generated propagated signal. Further, the computer storage medium may be or be included in one or more separate physical components or media (e.g., multiple CDs, disks, or other storage devices). The operations described herein may be implemented as operations performed by a data processing apparatus on data stored in one or more computer-readable storage devices or data received from other sources.

The above description is merely an illustrative description of the technical idea of the present disclosure, and those skilled in the art to which the present disclosure pertains will be able to make various modifications and variations without departing from the essential characteristics of the present technical idea. In addition, the embodiments of the present disclosure are not intended to limit the technical idea of the present disclosure but to explain it, and thus the scope of the technical idea of the present disclosure is not limited by these embodiments. The protection scope of the present disclosure should be interpreted by the following claims, and all technical ideas within the equivalent range should be interpreted as being included in the scope of rights of the present disclosure.

What is claimed is:

1. A Steer by Wire (SbW) steering control system performing reprogramming, the steering control system comprising:
an input-side steering control device comprising a first input-side control module and a second input-side control module configured to control an input-side steering motor connected to a steering wheel,
wherein the first input-side control module and the second input-side control module are configured to receive a first signed firmware and a second signed firmware from a communication device, respectively, in a normal state, and perform the reprogramming by applying a first valid firmware and a second valid firmware obtained through an integrity verification procedure, respectively, and
wherein the first input-side control module is configured to, when the second signed firmware is not received by the second input-side control module from the communication device, receive a third signed firmware, in which a first firmware and the second signed firmware are integrated, from the communication device, perform the integrity verification procedure on the third signed firmware to obtain the second signed firmware, and transmit the second signed firmware to the second input-side control module.

2. The steering control system of claim 1, wherein the first signed firmware is received from the communication device through a first communication channel, and
the second signed firmware is received from the communication device through a second communication channel.

3. The steering control system of claim 2, wherein the case where the second signed firmware is not received by the second input-side control module from the communication device comprises a case where a failure occurs in the second communication channel.

4. The steering control system of claim 1, wherein the third signed firmware is generated through a digital signature procedure on data in which the first firmware and the second signed firmware are integrated.

5. The steering control system of claim 1, wherein the first input-side control module is configured to, when the second signed firmware is not received by the second input-side control module from the communication device, perform the integrity verification procedure on the third signed firmware to obtain the first valid firmware and the second signed firmware.

6. The steering control system of claim 5, wherein the integrity verification procedure performed on the third signed firmware comprises verifying validity of a signed hash value of the third signed firmware using a public key, and comparing the verified hash value with a hash value generated from the third signed firmware.

7. The steering control system of claim 1, wherein the first input-side control module is configured to transmit the second signed firmware through a first Inter Micro Communication (IMC) path between the first input-side control module and the second input-side control module.

8. The steering control system of claim 1, wherein the first signed firmware, the second signed firmware, and the third signed firmware are generated in an external server through a digital signature procedure and transmitted to the communication device.

9. The steering control system of claim 8, wherein the first input-side control module is configured to, when the second signed firmware is not received by the second input-side control module from the communication device, transmit a request signal for the third signed firmware to the external server.

10. The steering control system of claim 1, further comprising an output-side steering control device comprising a first output-side control module and a second output-side control module configured to control an output-side steering motor connected to a wheel,
wherein the first output-side control module and the second output-side control module are configured to receive a fourth signed firmware and a fifth signed firmware from the communication device, respectively, in a normal state, and perform the reprogramming by applying a fourth valid firmware and a fifth valid firmware obtained through the integrity verification procedure, respectively, and
wherein the first output-side control module is configured to, when the fifth signed firmware is not received by the second output-side control module from the communication device, receive a sixth signed firmware, in which a fourth firmware and the fifth signed firmware are integrated, from the communication device, perform the integrity verification procedure on the sixth signed firmware to obtain the fifth signed firmware, and transmit the fifth signed firmware to the second output-side control module.

11. A reprogramming method performed in a Steer by Wire (SbW) steering control system comprising an input-side steering control device comprising a first input-side control module and a second input-side control module configured to control an input-side steering motor connected to a steering wheel, the method comprising:
receiving, by the first input-side control module, a first signed firmware from a communication device in a normal state, and performing reprogramming by applying a first valid firmware obtained through an integrity verification procedure; and
receiving, by the second input-side control module, a second signed firmware from the communication device in a normal state, and performing reprogramming by applying a second valid firmware obtained through the integrity verification procedure,
wherein the method further comprises, when the second signed firmware is not received by the second input-side control module from the communication device, receiving, by the first input-side control module, a third signed firmware, in which a first firmware and the second signed firmware are integrated, from the communication device, performing the integrity verification procedure on the third signed firmware to obtain the second signed firmware, and transmitting the second signed firmware to the second input-side control module.

12. The method of claim 11, wherein the first signed firmware is received from the communication device through a first communication channel, and
the second signed firmware is received from the communication device through a second communication channel.

13. The method of claim 12, wherein the case where the second signed firmware is not received by the second input-side control module from the communication device comprises a case where a failure occurs in the second communication channel.

14. The method of claim 11, wherein the third signed firmware is generated through a digital signature procedure on data in which the first firmware and the second signed firmware are integrated.

15. The method of claim 11, wherein the transmitting of the second signed firmware to the second input-side control module comprises, when the second signed firmware is not received by the second input-side control module from the communication device, performing the integrity verification procedure on the third signed firmware to obtain the first valid firmware and the second signed firmware.

16. The method of claim 15, wherein the integrity verification procedure performed on the third signed firmware comprises verifying validity of a signed hash value of the third signed firmware using a public key, and comparing the verified hash value with a hash value generated from the third signed firmware.

17. The method of claim 11, wherein the transmitting of the second signed firmware to the second input-side control module comprises transmitting the second signed firmware through a first Inter Micro Communication (IMC) path between the first input-side control module and the second input-side control module.

18. The method of claim 11, wherein the first signed firmware, the second signed firmware, and the third signed firmware are generated in an external server through a digital signature procedure and transmitted to the communication device.

19. The method of claim 18, wherein the transmitting of the second signed firmware to the second input-side control module comprises, when the second signed firmware is not received by the second input-side control module from the communication device, transmitting a request signal for the third signed firmware to the external server.

20. A control system performing reprogramming, the control system comprising:
a control device comprising a first control module and a second control module configured to be mutually redundant to control a first control target,
wherein the first control module and the second control module are configured to receive a first signed firmware and a second signed firmware from a communication device, respectively, in a normal state, and perform the reprogramming by applying a first valid firmware and a second valid firmware obtained through an integrity verification procedure, respectively, and
wherein the first control module is configured to, when the second signed firmware is not received by the second control module from the communication device, receive a third signed firmware, in which a first firmware and the second signed firmware are integrated, from the communication device, perform the integrity verification procedure on the third signed firmware to obtain the second signed firmware, and transmit the second signed firmware to the second control module.
